(19) United States
(12) Patent Application Publication
(10) Pub. No.: US 2025/0071368 A1
(43) Pub. Date: Feb. 27, 2025

(54) IMPLEMENTATIONS AND METHODS FOR USING MOBILE DEVICES TO COMMUNICATE WITH A NEURAL NETWORK SEMICONDUCTOR

(71) Applicant: Uniquify, Inc., Santa Clara, CA (US)

(72) Inventors: Joshua Jungho LEE, San Jose, CA (US); Samjung KIM, San Jose, CA (US)

(21) Appl. No.: 18/726,723

(22) PCT Filed: Jan. 4, 2023
(86) PCT No.: PCT/US2023/010137

§ 371 Date: Jul. 3, 2024

Related U.S. Application Data
(60) Provisional application No. 63/296,366, filed on Jan. 4, 2022.

(51) Int. Cl. H04N 21/431; H04N 21/2187; H04N 21/466; H04N 21/4725; H04N 21/475; H04N 21/4788

(52) U.S. Cl. CPC H04N 21/4316; H04N 21/2187; H04N 21/4662; H04N 21/4725; H04N 21/4758; H04N 21/4788

(57) ABSTRACT

Systems and methods described herein involve executing, using an artificial intelligence System on Chip (AI SoC), a machine learning model on received televised content, the machine learning model configured to identify objects displayed on the received televised content; displaying, through a mobile application interface, the identified objects for selection; and for a selection of one or more objects from the identified objects and an overlay through the mobile application interface, modifying a display of the received televised content to display the overlay.

### CROSS REFERENCE TO RELATED APPLICATIONS

This application claims priority to U.S. Provisional Patent Application No. 63/296,366, filed Jan. 4, 2022, the contents of which are incorporated herein by reference in its entirety for all purposes.

### BACKGROUND

### Field

The present disclosure is directed to mobile device applications, and more specifically, to mobile devices and applications thereof to interact with neural network semiconductors.

### Related Art

There are many forms of consumer content today. First to define the term, “consumer content” is any visual, audible, and language content that consumers digest. As an example, television (TV) consumer content involves images, videos, sound, and texts. The delivery mechanisms for these consumer contents include, ethernet, satellite, cables, and Wi-Fi. The devices that are used to deliver the contents are TV, mobile phone, automobile display, surveillance camera display, personal computer (PC), tablet, augmented reality/virtual reality (AR/VR) devices, and various Internet of Things (IoT) devices. Consumer content can be also divided into “real-time” content such as live sporting events, or “prepared” content such as movies and sitcoms. Today, both “real-time” and “prepared” consumer contents are presented to consumers without any further annotation or processing.

### SUMMARY

Example implementations described herein involve an approach to process consumer content and connect appropriate cloud information found for relevant parts of the consumer content to present to the consumers. Such example implementations can involve classifying and identifying persons, objects, concepts, scenes, text, language, and so on in consumer content, annotating the things classified in the content with relevant information in the cloud, and presenting the annotated content to consumers.

The Classification/identification process is a step that processes image, video, sound, and language to identify person (who someone is), class of objects (such as car, boat, etc.), meaning of a text/language, any concept, or any scene. A good example of a method that can accomplish this classification step is various Artificial Intelligence (AI) models that can classify images, videos, and language. However, there could be other alternative methods such as conventional algorithms. The definition of the cloud is any information present in any servers, any form of database, any computer memory, any storage devices, or any consumer devices.

Aspects of the present disclosure can involve a method, which can involve executing, using an artificial intelligence System on Chip (AI SOC), a machine learning model on received televised content, the machine learning model configured to identify objects displayed on the received televised content; displaying, through a mobile application interface, the identified objects for selection; and for a selection of one or more objects from the identified objects and an overlay through the mobile application interface, modifying a display of the received televised content to display the overlay.

Aspects of the present disclosure can involve a computer program, storing instructions for executing a process, the instructions involving receiving, from an artificial intelligence System on Chip (AI SOC), identified objects displayed on the received television content by a machine learning model; displaying, through a mobile application interface, the identified objects for selection; and for a selection of one or more objects from the identified objects and an overlay through the mobile application interface, transmit instructions to modify a display of the received televised content to display the overlay. The computer instructions can computer program can be stored on a non-transitory computer readable medium and executed by one or more processors.

Aspects of the present disclosure can involve a system, which can involve means for executing, using an artificial intelligence System on Chip (AI SOC), a machine learning model on received televised content, the machine learning model configured to identify objects displayed on the received televised content; means for displaying, through a mobile application interface, the identified objects for selection; and for a selection of one or more objects from the identified objects and an overlay through the mobile application interface, means for modifying a display of the received televised content to display the overlay.

Aspects of the present disclosure can involve a device such as a mobile device, that can involve a processor configured to receive, from an artificial intelligence System on Chip (AI SOC), identified objects displayed on the received television content by a machine learning model; display, through a mobile application interface, the identified objects for selection; and for a selection of one or more objects from the identified objects and an overlay through the mobile application interface, transmit instructions to modify a display of the received televised content to display the overlay.

### BRIEF DESCRIPTION OF DRAWINGS

FIG. 1 illustrates an example of how digital content is processed and supplemented with relevant information from the cloud, internet, systems, any database, and people (e.g., as input from their devices) in accordance with an example implementation.

FIG. 2 illustrates an overall architecture of AI-Cloud TV SoC, in accordance with an example implementation.

FIGS. 3A-3D illustrate examples of the AI edge devices in various systems, in accordance with example implementations.

FIG. 4 illustrates an example control architecture for the AI SoC, in accordance with an example implementation.

FIG. 5 illustrates an example communication tunnel between mobile device and AI SoC, in accordance with an example implementation.

FIG. 6A illustrates an example of multiple users connecting to an AI SoC, in accordance with an example implementation.

FIG. 6B illustrates an example of connecting multiple users together via internet, in accordance with an example implementation.

FIGS. 7 to 12 illustrate example usage cases for information overlay, in accordance with an example implementation.

FIGS. 13 to 16 illustrate example usage cases for social overlay, in accordance with an example implementation.

FIGS. 17A and 17B illustrate examples of display modes, in accordance with an example implementation.

FIGS. 18 to 22 illustrate examples of the user interface of the mobile device application for managing overlays, in accordance with an example implementation.

FIG. 23 illustrates an example of a mobile device, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

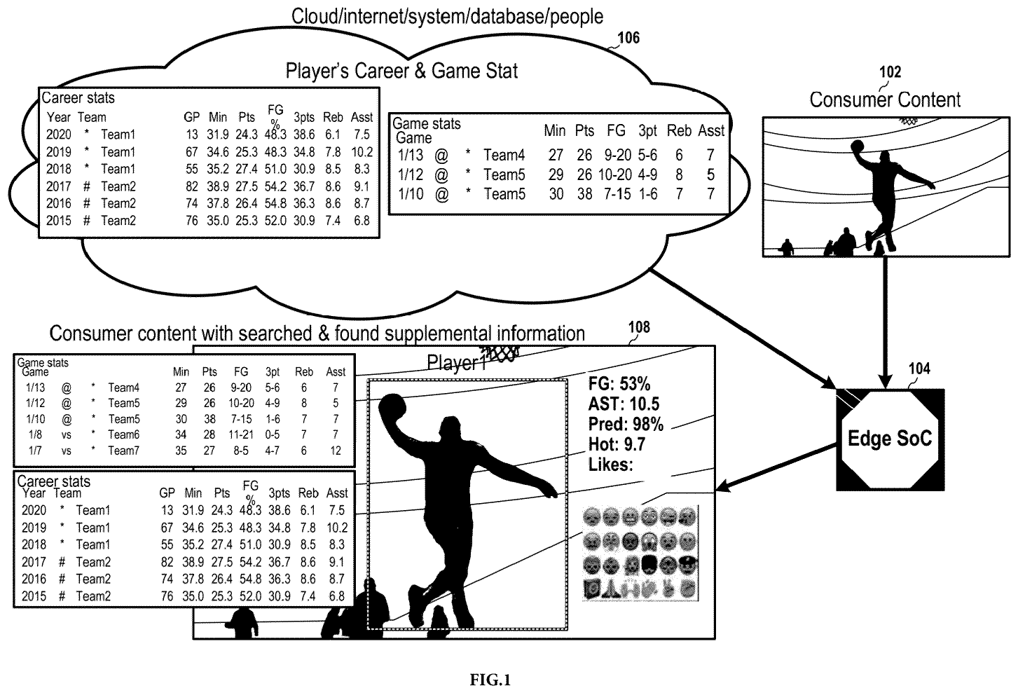

FIG. 1 illustrates an example of how digital content is processed and supplemented with relevant information from the cloud, internet, systems, any database, and people (e.g., as input from their devices) in accordance with an example implementation. Digital content 102 may be provided to an edge SoC device with an artificial intelligence processing element (AIPE) 104 to process the digital content 102. The SoC 104 may be a part of a network or a standalone edge device. (e.g., internet enabled TV or the like). The SoC 104 may receive the digital content 102 and may process the digital content to detect or classify objects within the digital content 102. For example, SoC 104 may process the digital content 102 and detect that the digital content 102 contains basketball players, basketball, and the basket. The SoC 104 may search and find the information in the cloud/internet/system/database/people 106 that is related to the processed digital content such as information on the basketball players. For example, the SoC 104 may detect or identify one or more players involved in the real-time sporting event as well as the respective teams. The cloud/internet/system/database/people 106 may include relevant information on the players and the SoC 104 may supplement the digital content 102 with the relevant information from the cloud/internet/system/database/people 106. The SoC 104 may then provide the digital content annotated with the information from the cloud/internet/system/database/people 106 onto an edge device 108 to display the digital content with the supplemental information to viewers. Viewers/consumers may have the option to display any supplemental information together with the digital content such as but not limited to, player identity, real-time statistics of the player, recent statistics of previous games, or season statistics over a period of time or career of the player, player's social media content, e-commerce info related to the players.

Artificial Intelligence Television (AI TV) is a TV that annotates the cloud information to TV content and delivers the annotated content to consumers in real time. The TVs of the related art are incapable of classifying TV content in real time (e.g., 60 frames per second). The current functions available for TVs in the related art involve delivering the content to consumers either by streaming the content from the internet (smart TV) or receiving the content via a set-top box, and receiving and processing the user inputs: remote control input, voice input, or camera input.

AI TV is a novel device that can classify and identify TV content in real time and find the relevant information in the cloud to annotate the content with the found information to present to the consumers by processing the content and running necessary classification and detection algorithms with an AI TV System on Chip (SoC) that has enough processing power to digest 60 frames per second. It also has capabilities to interact with the consumers to decide what to display, how to display, and when to display the annotated information.

Today's TV has roughly two types of System on Chips (SoCs): TV SoC and TCON (Timing Control) SoC. TV SoC is responsible for getting the content via internet (usually through Wi-Fi interface) or via set-top boxes through High-Definition Multimedia Interface (HDMI) interface and user interface signals from a remote-control device, a microphone, or a camera. Then TV SoC passes the images to the TCON (Timing Controller) SoC and the sound to the speakers. TCON SoC in turn enhances image quality and passes the image to the driver Integrated Circuit (IC's) to display the image on a screen. Some TVs combine TV SoC and TCON SoC into a single TV SoC.

In order to realize AI TV, a dedicated AI TV SoC is needed because the current TV SoCs and TCON SoCs do not have processing power nor the functionalities for AI TVs.

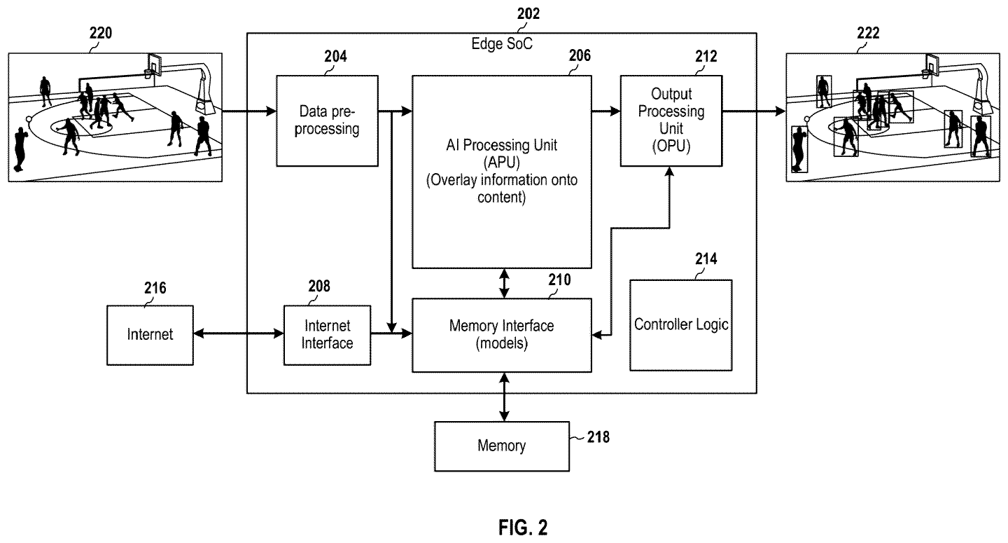

FIG. 2 illustrates an overall architecture of AI-Cloud TV SoC, in accordance with an example implementation. The AI-Cloud TV SoC 202 may be configured to process the digital content. The AI-Cloud TV SoC 202 may comprise a plurality of elements that are utilized in the processing of the digital content. For example, the AI-Cloud TV SoC 202 may comprise an input/pre-processing unit (IPU) 204, an AI processing unit (APU) 206, an internet interface 208, a memory interface 210, an output processing unit (OPU) 212, and a controller logic 214.

The IPU 204 may receive, as input, the digital content 220. The IPU 204 may ready the digital content 220 to be used by the AI Processing Unit and the memory interface. For example, the IPU 204 may receive the digital content 220 as a plurality of frames and audio data, and readies the plurality of frames and audio data to be processed by the APU. The IPU 204 provides the readied digital content 220 to the APU 206. The APU 206 processes the digital content using various neural network models and other algorithms that it gets from the memory via the memory interface. For example, the memory interface 210 includes a plurality of neural network models and algorithms that may be utilized by the APU 206 to process the digital content.

The memory interface 210 may receive neural network models and algorithms from the cloud/internet/system/database/people 216. The APU may fetch the one or more AI/neural network models form the memory interface. The APU 206 may process the pre-processed input digital content with the one or more AI/neural network models. The internet interface 208 may search and find the relevant supplemental information of the processed digital content and provide the relevant supplemental information to the memory interface 210. The memory interface 210 receives, from the internet interface 208, information the from cloud/internet/system/database/people 216 that is relevant to the processed digital content. The information from the cloud/internet/system/database/people 216 may be stored in memory 218, and may also be provided to the OPU 212. The OPU 212 may utilize the information from the cloud/internet/system/database/people 216 to supplement the digital content and may provide the supplemental information and the digital content to the consumers/viewers. The information from the internet may be stored on the memory 218 and may be accessible to the OPU. The OPU may access the information stored on the memory 218 via the memory interface 210. The memory 218 may be internal memory or external memory. The OPU 212 prepares the supplemental information and the digital content 222 to be displayed on a display device. The controller logic 214 may include instructions for operation of the IPU 204, APU 206, the OPU 212, internet interface, and the memory interface 210.

The above architecture may also be utilized to process audio within the digital content 220. For example, the APU 206 may process the audio portion of the digital content and convert the audio to text, and uses natural language processing neural network models or algorithms to process the audio content. The internet interface may find the relevant information from the cloud/internet/system/database/people and create supplemental information, and OPU prepares the supplemental information and the digital content to present to the edge device in a similar manner as discussed above for the plurality of frames.

As illustrated, the AI-Cloud TV SoC receives the input frames from TV SoC and classifies the content using AI models which are processed in the AI Processing Unit. Then it connects to the cloud through Wi-Fi interface to annotate any relevant information from the cloud to the actual content/frame then present the annotated content to viewers.

AI TV SoC can be used inside a TV, a set-top-box (STB), a stream device, or a standalone device.

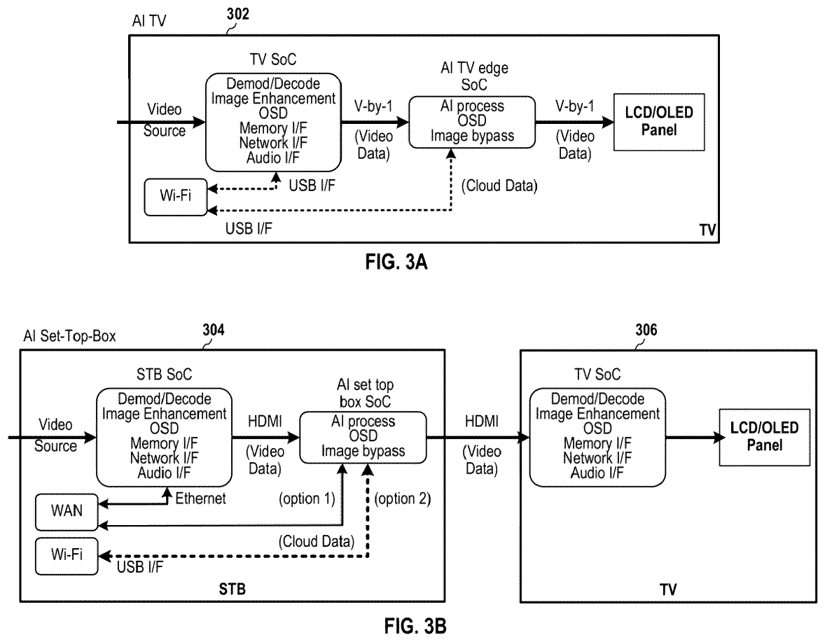

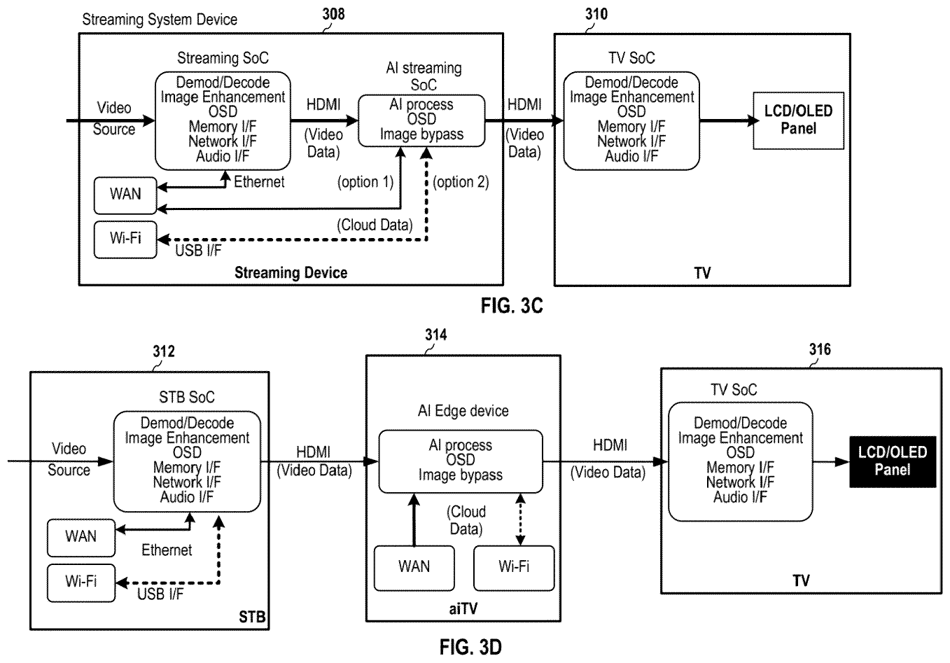

FIGS. 3A-3D illustrate examples of the AI edge devices in various systems, in accordance with example implementations. FIG. 3A provides an example of an AI TV 302 that comprises a TV SoC, an AI TV edge SoC, and a display panel in a fully integrated device. The AI TV 302 includes the AI TV edge SoC that processes the digital content and provides supplemental information to the digital content comprising relevant data/information associated with the digital content attained from the cloud/internet/system/database/people to be used by the AI TV 302. FIG. 3B provides an example of an AI set top box 304 that is an external device that is configured to be connected to a TV 306. The AI set top box 304 may be connected to the TV 306 via an HDMI connection, but other connections may be utilized for connecting the AI set top box 304 and the TV 306. The AI set top box 304 comprises a set top box (STB) SoC and an AI set top box SoC. The AI set top box 304 receives the digital content and processes the digital content and provides, as output, supplemental information to the digital content comprising relevant data/information associated with the digital content attained from the cloud/internet/system/database/people. The supplemental information along with the digital content may be provided to the TV 306 via the HDMI connection. FIG. 3C provides an example of a streaming system device 308 that is an external device configured to be connected to a TV 310. The streaming system device 308 may be connected to the TV 310 via an HDMI connection, but other connections may be utilized for connecting the streaming system device 308 and the TV 310. The streaming system device 308 comprises a streaming SoC and an AI streaming SoC. The streaming system device 308 receives the digital content and processes the digital content and provides, as output, supplemental information to the digital content comprising relevant data associated with the digital content attained from the cloud/internet/system/database/people. The supplemental information along with the digital content may be provided to the TV 310 via the HDMI connection. FIG. 3D provides an example of an AI Edge device 314 that is a stand-alone device. The AI Edge device 314 receives the digital content from a set top box 312 via an HDMI connection and processes the digital content to provide supplemental information to the digital content comprising relevant data associated with the digital content attained from the cloud/internet/system/database/people. The AI Edge device 314 provides the supplemental information along with the digital content to a TV 316 via an HDMI connection.

Other implementations are also possible, and the present disclosure is not particularly limited to the implementations described herein. The AI SoC proposed herein can also be extended to other edge or server systems that can utilize such functions, including mobile devices, surveillance devices (e.g., cameras or other sensors connected to central stations or local user control systems), personal computers, tablets or other user equipment, vehicles (e.g., Advanced driver-assistance system (ADAS) systems, or Electronic Control Unit (ECU) based systems), Internet of Things edge devices (e.g., aggregators, gateways, routers), Augmented Reality/Virtual Reality (AR/VR) systems, smart homes and other smart system implementations, and so on in accordance with the desired implementation.

### Controls for AI SoC

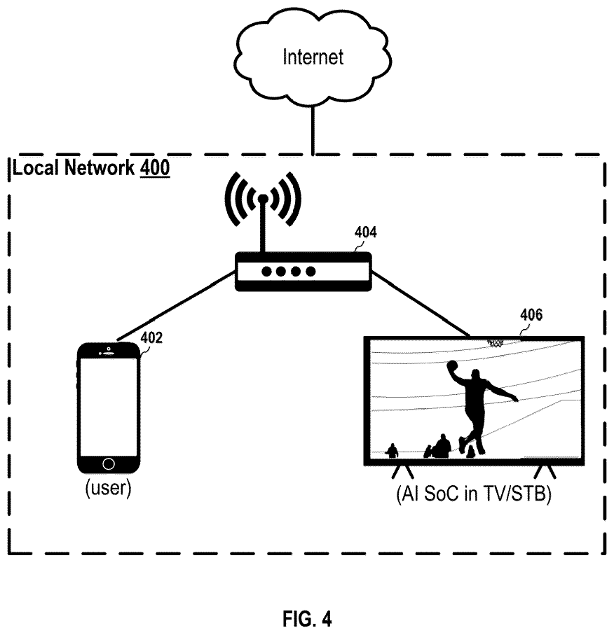

FIG. 4 illustrates an example control architecture for the AI SoC, in accordance with an example implementation. There are many configurations and settings that users can change, and a simple device like a remote control cannot handle complexities. A mobile device 402 such as a smart phone, or a tablet with Wi-Fi capability or any device that is connected to a local network 400 with a wired connection is used to establish a communication channel between users and AI SoC 406 such as in the AI TV. Both a mobile device 402 and AI SoC 406 are connected to the same local network 400 via a network device 404 such as a router or a switch so that the device can communicate with AI SoC through a standard network protocol such as Transmission Control Protocol/Internet Protocol (TCP/IP).

The mobile device 402 acts as a remote control for AI TV. Users can download a mobile application (mobile application) and install it on a mobile device 402, and connects to an AI SoC 406 on the same local network 400. At first, a user can install a mobile application on a mobile device 402 such as a smart phone or tablet. Then, the mobile application searches for an AI SoC (or AI SoCs) in the local network 400. Finally, the mobile application creates a communication tunnel (i.e. TCP/IP) to an AI SoC 406.

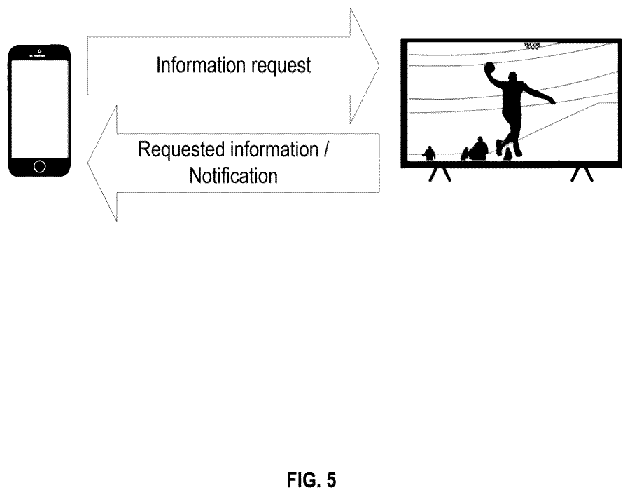

FIG. 5 illustrates an example communication tunnel between mobile device and AI SoC, in accordance with an example implementation. Once a communication tunnel is established between the mobile device (through the mobile application) and AI SoC, information can flow between the mobile device (mobile application) and AI SoC. The mobile application requests data to AI SoC, and it returns requested information back to the mobile application. Multiple users using a different mobile device can be connected to the same AI SoC. Each mobile device (mobile application) is assigned to a different user. Each user can have a different set of controls/settings for his or her preference.

### Multiple Users Connecting to One AI SoC

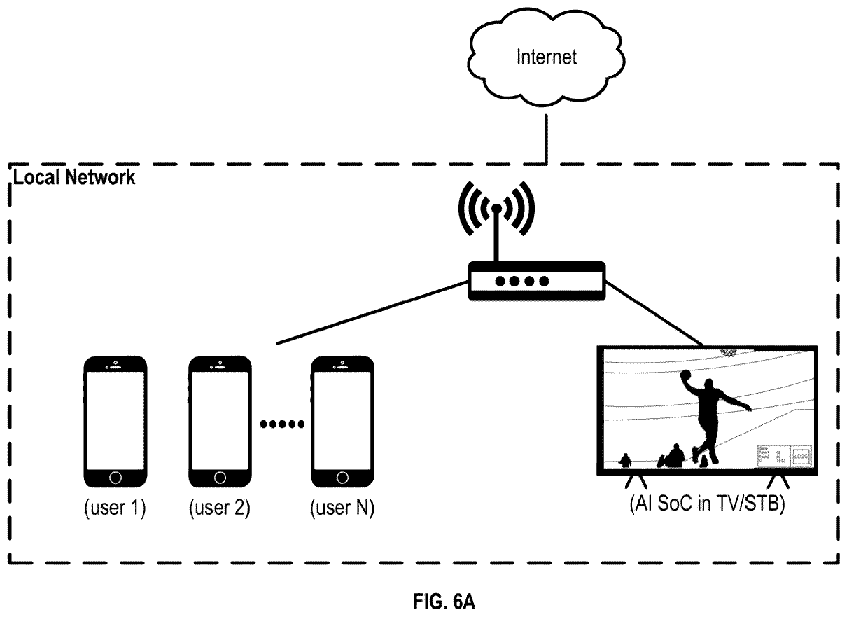

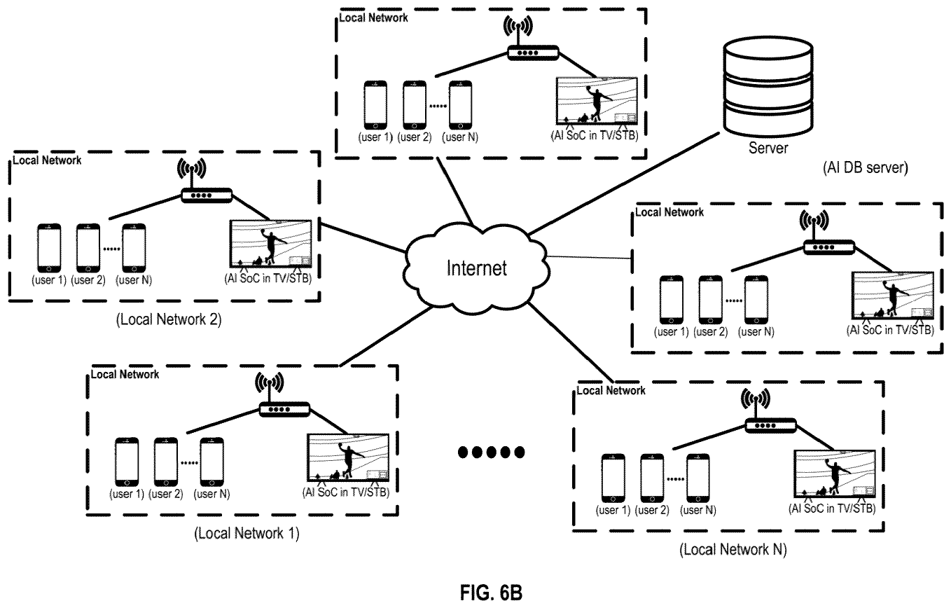

FIG. 6A illustrates an example of multiple users connecting to an AI SoC, in accordance with an example implementation. User 1, User 2 . . . . User N are all connected to AI SoC. User 1, User 2 . . . . User N can send requests to AI SoC. AI SoC can send requested information to a specific user. AI SoC can send notifications to all connected devices.

### Connecting Users Together

FIG. 6B illustrates an example of connecting multiple users together via internet, in accordance with an example implementation. Users in the local network are all connected within the local network. Users outside a local network can be also connected through internet connection. Multiple local networks are connected through Internet, so all users are connected and can communicate each other, which in turns creates a virtual social community of AI SoC (AI TV/STB) users.

All user configurations can be controlled by mobile application. Mobile application can control all configurable switches in AI SoC. Below are some example configurations that can be controlled by a mobile application.

Channel selection: users can change the channel of their AI TV/STB through the function on the mobile application.

AI model selection: users can select an AI model to load into memory for processing by the AI SoC.

Display configuration: such as how information is displayed on the TV screen and mobile screen.

Classified object selection: selectin a classified object for highlighting or other purposes such as image, audio, and/or text objects

Information selection: selecting information displayed on the screen.

Visual effect selection: adding or removing visual effects on the screen or live broadcast (e.g., selecting a basketball and adding a fire effect during a broadcasted basketball game).

Friends (e.g., users that are connected) selection: add or remove selected friends to exchange information on the TV or mobile display.

Action selection: display information, display visual effect, share chats/information with other users (e.g., friends).

Sending information to AI SoC: such as instructions to execute a model

Sending information to AI DB server: such as instructions to retrieve new model

Receiving information from AI SoC: such as results from the executed model

Receiving information from AI DB server: such as new models or additional metadata.

Through a mobile app, users can display various information, and visual effects on the screen of an AI TV and/or the screen of the mobile devices. Applications can be categorized into three types: information overlay, visual overlay, and social overlay.

Information is about the classified and identified persons, objects, concepts, scenes, text, language in consumer content that is processed by AI SoC. It comes from the AI DB server and/or from the Internet (e.g., search result from the Internet in accordance with the desired implementation).

Information overlay displays specific information about the classified object(s) selected by a user. Information can be displayed on the screen of an AI TV or the mobile device. It can be any information about the classified objects, sounds/audios, and texts.

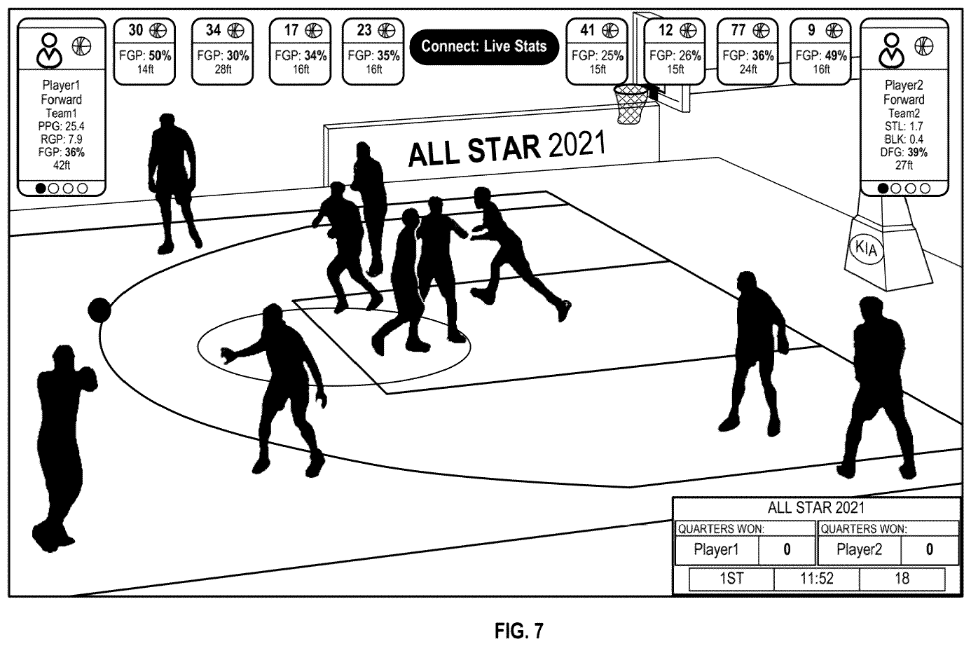

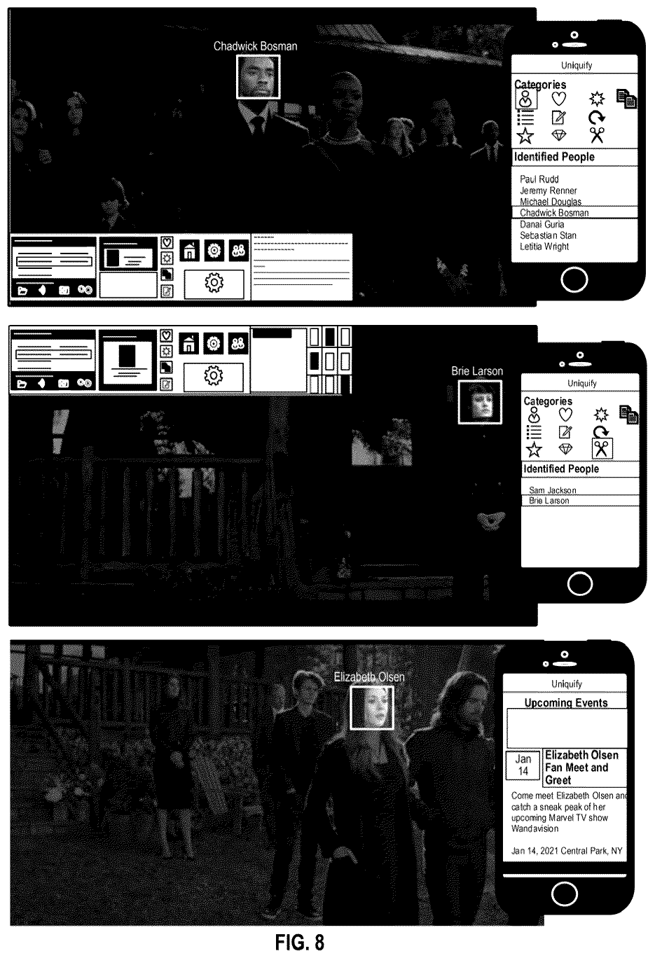

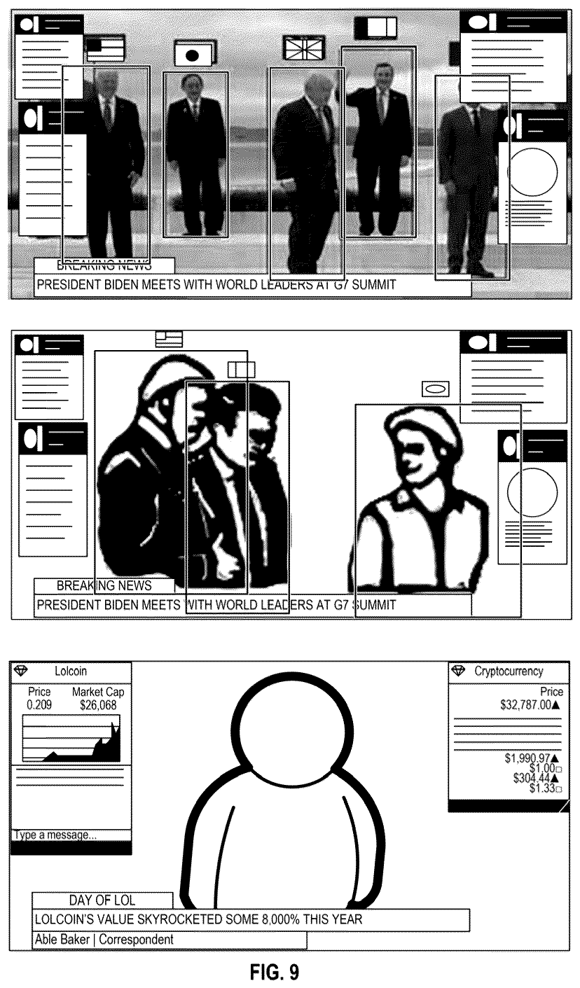

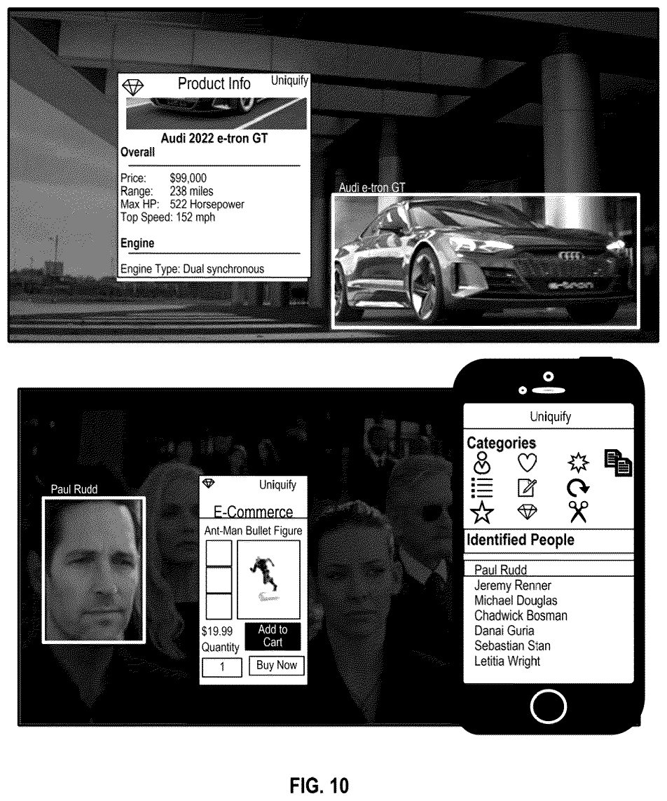

FIGS. 7 to 12 illustrate example usage cases for information overlay, in accordance with an example implementation. Information such as detailed statistics about each player in a sport game can be display on the screen as illustrated in FIG. 7. Information about an actor or actress can be display on the screen and the mobile application can choose which actor or actress to choose and what kind of information that is display such as news, trending, social media about specific actors and/or actresses as illustrated in FIG. 8. Users can display more information about news segment from various sources (e.g., different news channels or internet sources) as illustrated in FIG. 9. Types of information are selected by a user on a mobile application. Information such as price, rating, and e-commerce site about a product, which is classified by AI SoC can be displayed and a link to an e-commerce site can be provided to users as illustrated in FIG. 10.

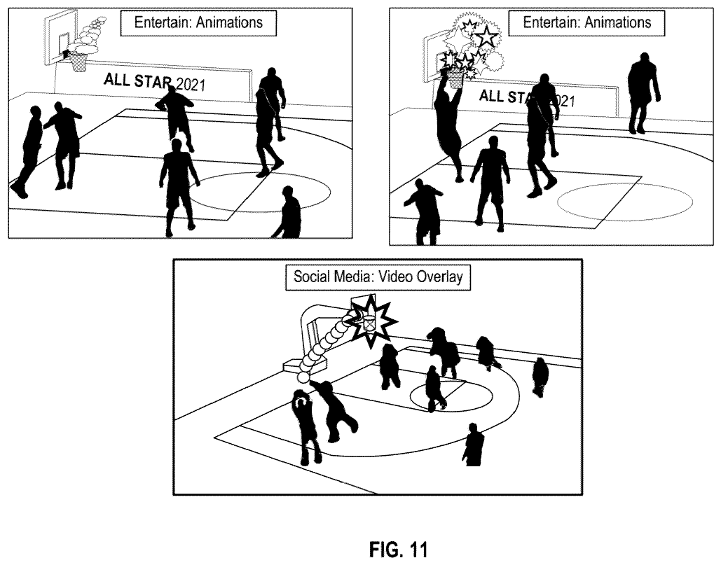

Visual overlay provides users capabilities of editing contents on the fly. Various visual effects and/or animation can be overlaid on top or nearby the objects that are classified by AI SoC. The location of the visual overlays and types of visual effects can be selected by users on the mobile application. FIG. 11 illustrates an example of adding visual overlays, in accordance with an example implementation. In a sport game as illustrated in FIG. 11, a visual effect such as a fire ball or water splash can be overlaid on the basketball when a specified player takes a shot. When a special performance or event (i.e. a dunk) happens in a basketball game by a specified player, a firework effect on the basket can also be created.

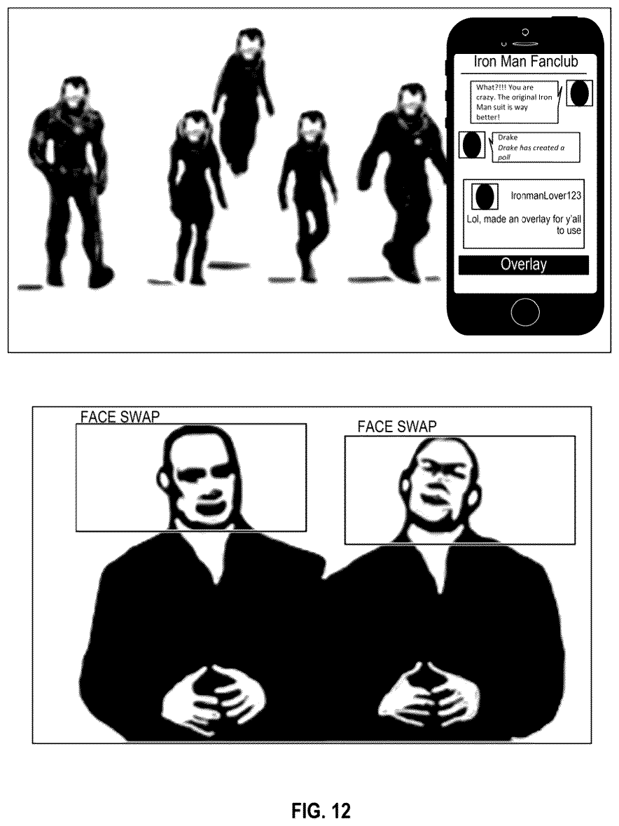

In the example of FIG. 12, users can also overlay images on top of other character's faces depending on the desired implementation. For example, by using known AI models and techniques such as deep fake, the face of one character can be swapped with a different face (e.g., another character, an animated icon, another person, etc.)

Example implementations can also utilize social overlays, which provides users with the ability of sharing “information overlay” and “visual overlay” with friends (other users) who are connected. All users are connected together via AI SoC network, and a group of users (friends) can be formed who are willing to share more information such as:
1. User preferences (e.g., AI model selection, favorite shows/channels, favorite characters/objects, and so on)
2. Sending information overlay and visual overlay to friends
3. Receiving information overlay and visual overlay from friends
4. Sharing text/voice messages among a group of friends or an individual in a group of friends

A group of users (friend) can also form a social group for a specific content and share information among a social group. This can create a virtual environment where users in a social group are watching the content together side by side (e.g., virtual stadium, virtual theater, and so on). A user can send “information overlay” and/or “visual overlay” to another friend (or friends) in a social group. “Information overlay” and/or “visual overlay” can be displayed on the screen of multiple users that are connected as “friends”. For example, one user can send a visual overlay to another user in the same social group, and have the visual overlay display on the display or mobile device of the another user.

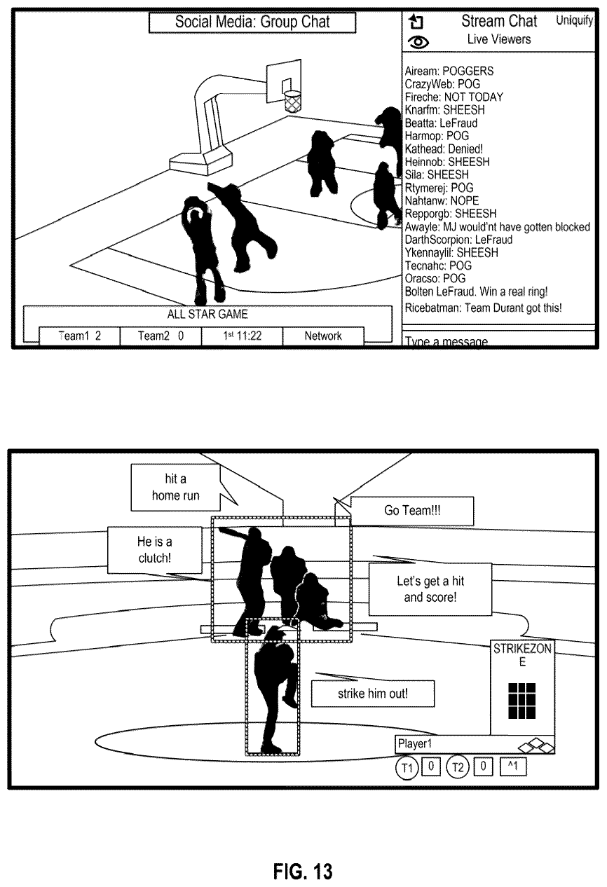

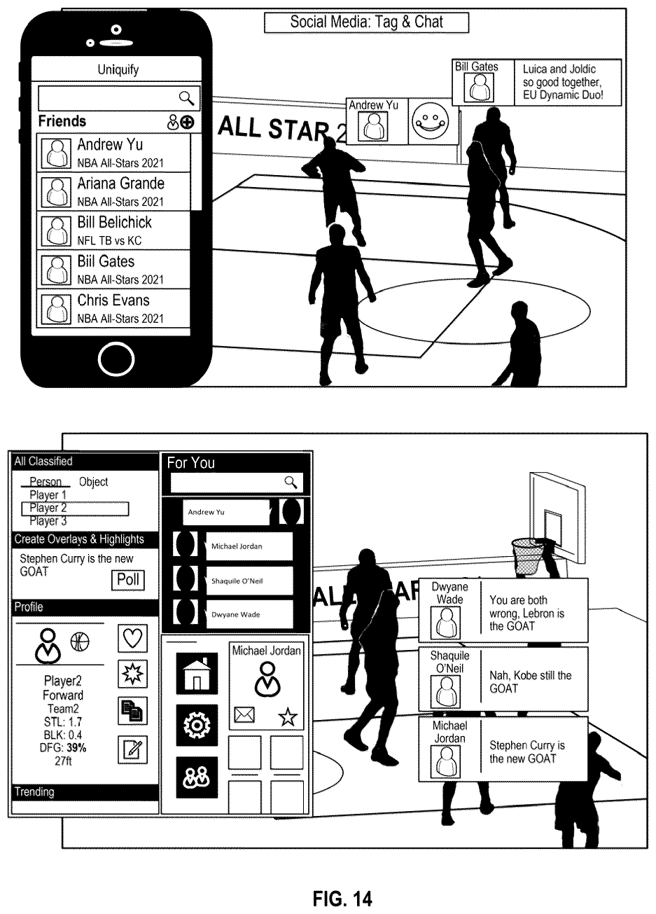

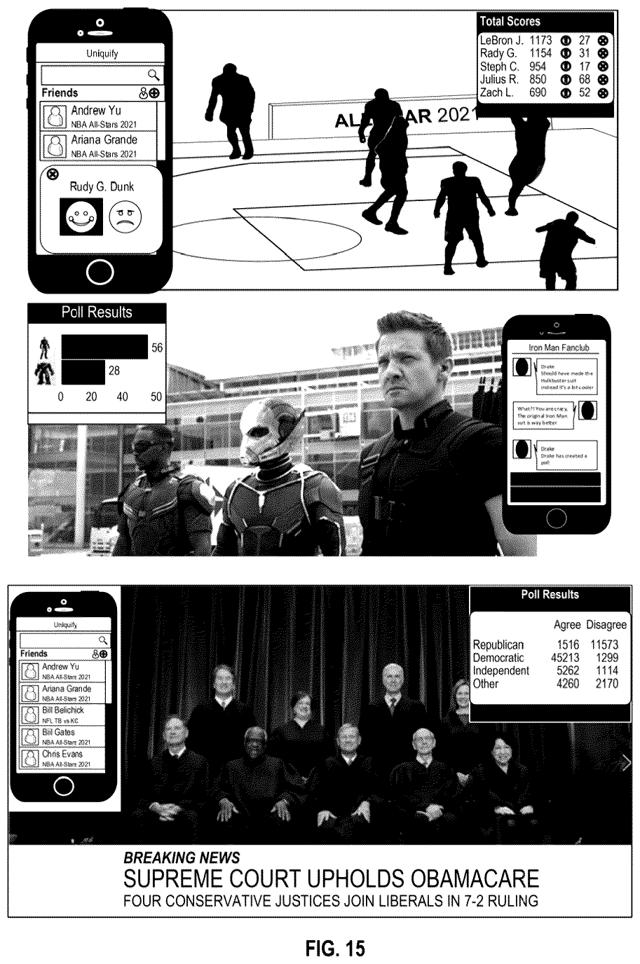

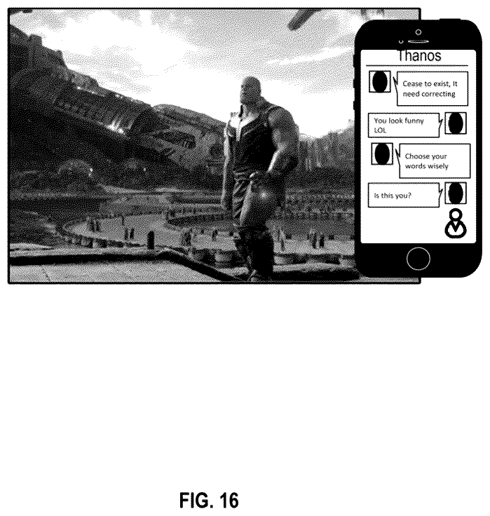

FIGS. 13 to 16 illustrate example usage cases for social overlay, in accordance with an example implementation. Users in a social group can exchange texts (chats) and can create information overlay and visual overlay on classified objects by AI SoC as illustrated in FIG. 13. Friends can send texts (as visual overlay) to other friends watching the same content, which can create a virtual environment as if multiple friends are watching in the same room as illustrated in FIG. 13. A user can send a text to another user in his or her friends group and can be displayed over any classified object as illustrated in FIG. 14. Information gathering such as a voting can be performed among friends—simply asking for a thumb up or down, or posting a simple question as illustrated in FIG. 15. A user (or users) can chat with a character in a movie/show provided by AI chatbots as illustrated in FIG. 16. Other examples for social overlays can also be utilized, and the present disclosure is not limited thereto. For example, users can become a participant in a game show by entering the answer, and users can become a judge and cast a vote in a show, depending on the desired implementation.

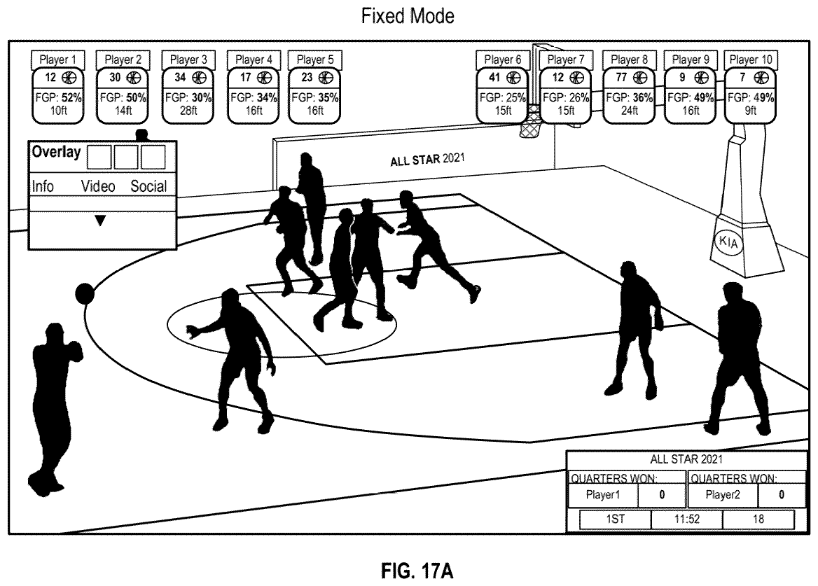

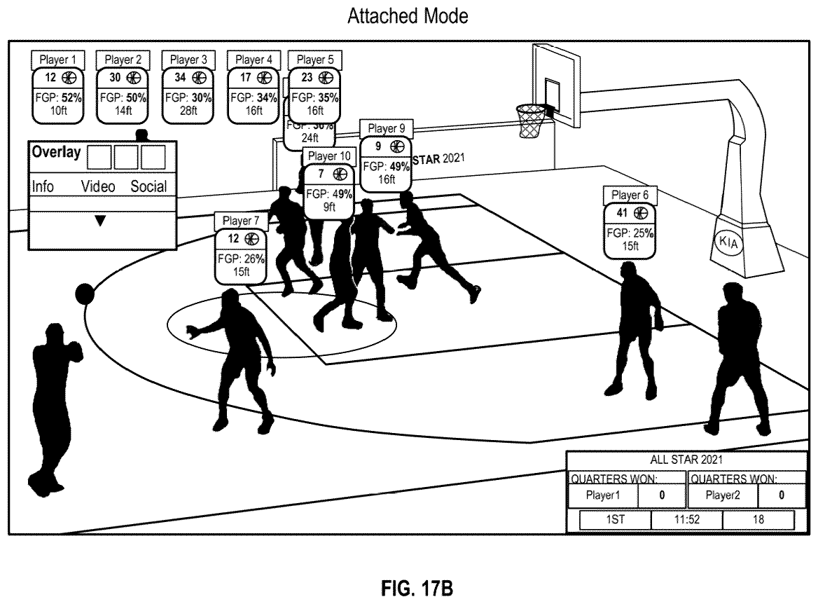

FIGS. 17A and 17B illustrate examples of display modes, in accordance with an example implementation. Multiple display modes are provided for information overlay, visual overlay and social overlay. In one example as illustrated in FIG. 17A, the “Fixed mode” displays information in a fixed location such as top (or bottom, left, right) area of the screen. In another example as illustrated in FIG. 17B, the “Attached mode” display information nearby the object classified. Users can select a relative location from the object. Other display modes are also possible, and the present disclosure is not limited thereto. For example, information can be displayed outside of the content instead.

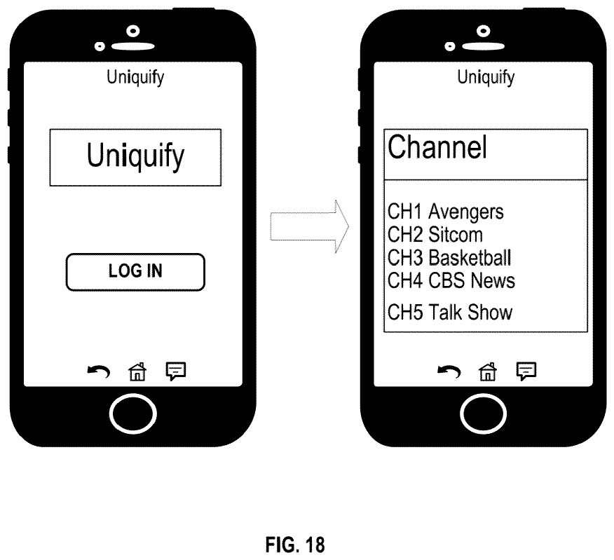

FIGS. 18 to 22 illustrate examples of the user interface of the mobile device application for managing overlays, in accordance with an example implementation. In the example of FIG. 18, users can use their mobile device to change the channel on their television screen through a dropdown selection box.

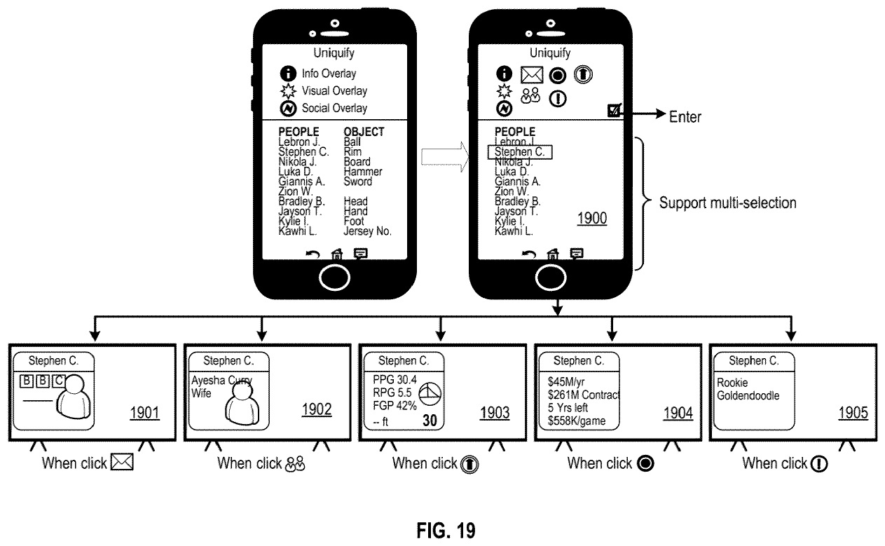

Various icons and menus can be provided by the user interface for selection to implement an information overlay, a visual overlay, a social overlay, and so on, in accordance with an example implementation. For a given television program, detected people and objects from the AI SoC can be provided for selection to select either the overlay to be provided on, or to provide other information in accordance with the desired implementation. In the example of FIG. 19, a person “Stephen C.” is selected as the object of interest as shown in screen 1900. Subsequently, when the news icon is selected, then a link to a news article or headline can be provided as an information overlay as shown at 1901. When selecting the friends or related persons icon, then relatives or known associates can be provided as an information overlay as shown at 1902. When the stats button is selected, then various statistics for the selected person (e.g., sports statistics) can be provided as an information overlay as shown at 1903. Other examples illustrated in FIG. 19 include salary/budget statistics 1904, and nicknames 1905. The desired information can be adjusted according to the desired implementation and can be customizable (e.g., based on the underlying television program, etc.) and the present disclosure is not limited thereto.

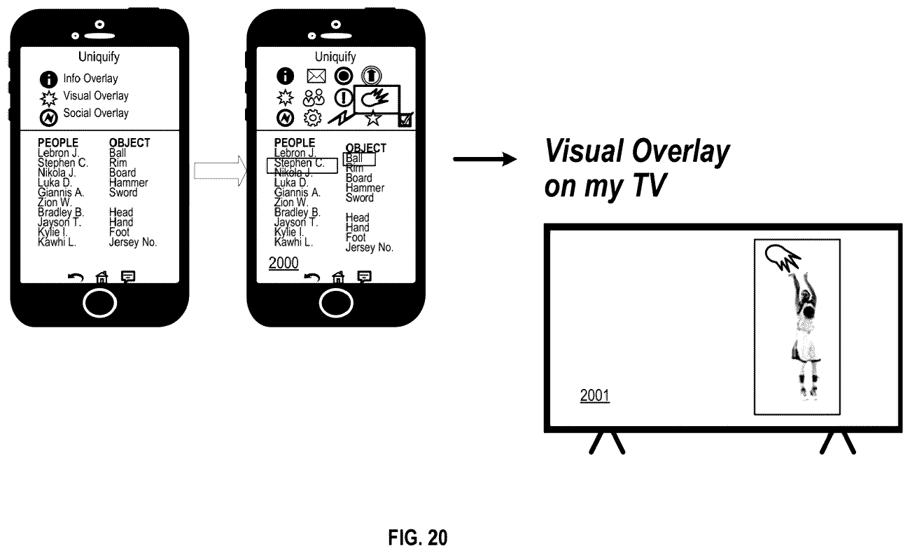

FIG. 20 illustrates an example interface for providing visual overlays on the television, in accordance with an example implementation. Specifically, after receiving a user selection through the interface screen shown at 2000 (“Stephen C.” and “ball”), a fireball is selected as the visual overlay to replace the ball with a fireball overlay when the ball is controlled by “Stephen C.” in a basketball game. Once the checkmark button is selected, then the visual overlay is activated and will be shown during the broadcast of the television program as illustrated at 2001. Through this manner, users can apply different Visual Overlays to each People and Object, or combination thereof. Visual overlays can be provided on people, objects, or when both are selected, on objects when the object is controlled by the selected person.

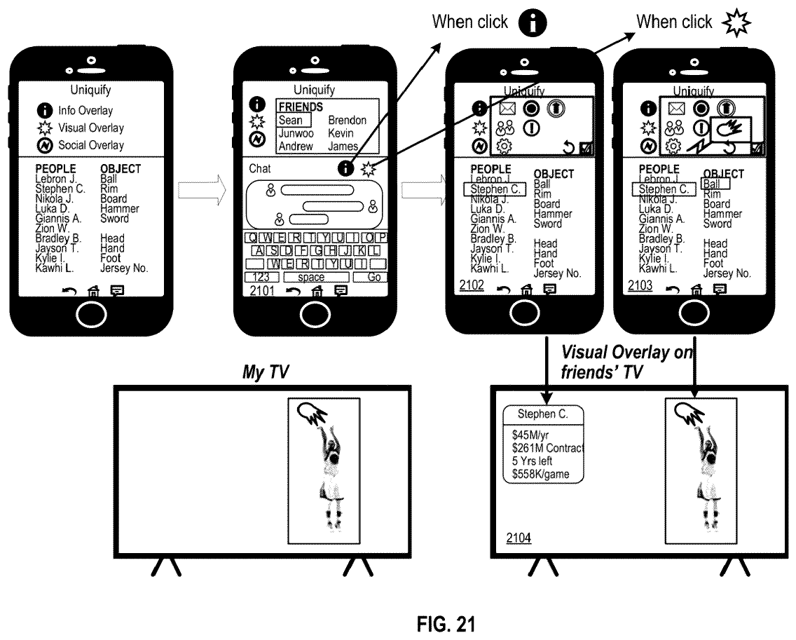

FIG. 21 illustrates an example interface for providing social overlays on another person's television, in accordance with an example implementation. Through the interface of the mobile application, the user can select a friend who is watching the same program at 2101 to add a social overlay, as well as the type of overlay to display on the friend's screen. For example, if the user wishes to add an information overlay to the friend's screen as shown at 2102, or a visual overlay as shown at 2103, such overlays can then be displayed on the friend's screen as shown at 2104.

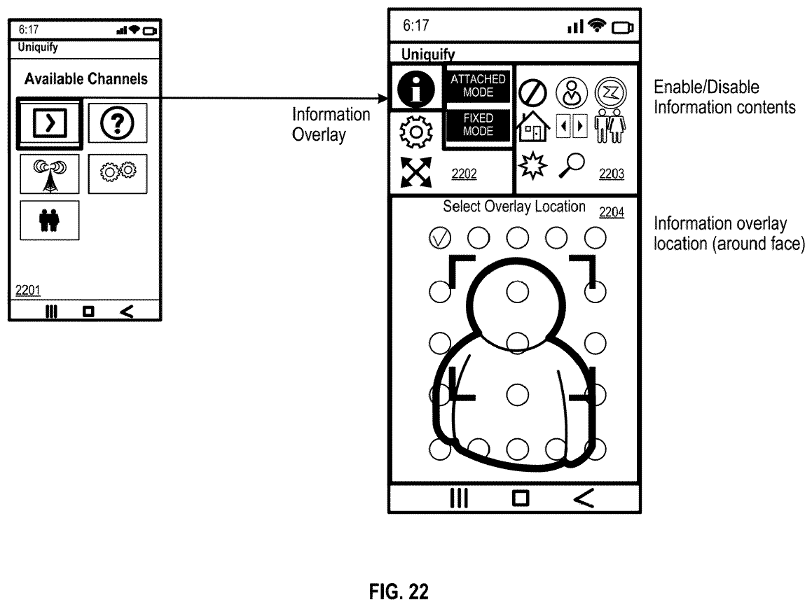

FIG. 22 illustrates an example interface for customizing the location and other aspects of the overlays, in accordance with an example implementation. The settings for the information overlay can be accessible through the user interface as shown at 2201. Settings that can be adjusted for the overlay can involve changing the display mode of the overlays for each type of overlay as shown at 2202, enable/disable different overlays 2203, as well as being able to configure the location of the overlay on the object (e.g., a person) as shown at 2204.

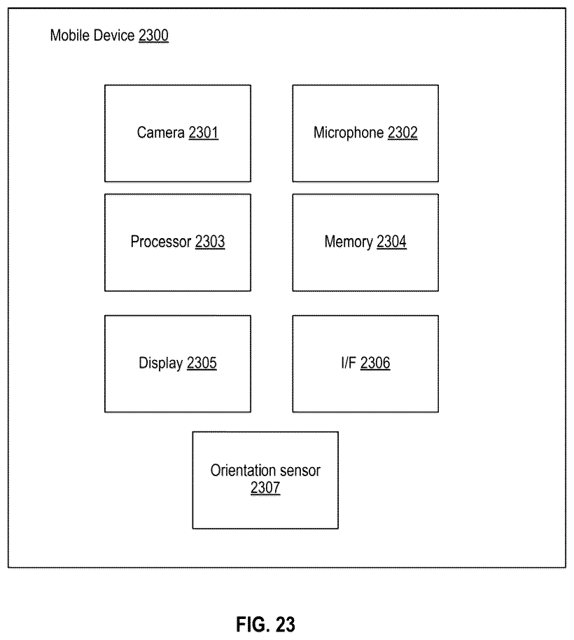

FIG. 23 illustrates an example of a mobile device, in accordance with an example implementation. Mobile device 2300 can include camera 2301, microphone 2302, processor 2303, memory 2304, display 2305, interface (I/F) 2306 and orientation sensor 2307. Camera 2301 can include any type of camera that is configured to record any form of video in accordance with the desired implementation. Microphone 2302 can involve any form of microphone that is configured to record any form of audio in accordance with the desired implementation. Display 2305 can involve a touch screen display configured to receive touch input to facilitate instructions to execute the functions as described herein, or a normal display such as a liquid crystal display (LCD) or any other display in accordance with the desired implementation. I/F 2306 can include network interfaces to facilitate connections of the mobile device 2300 to external elements such as the server and any other device in accordance with the desired implementations. Processor 2303 can be in the form of hardware processors such as central processing units (CPUs) or in a combination of hardware and software units in accordance with the desired implementation. The orientation sensor 2307 can involve any form of gyroscope and/or accelerometer that is configured to measure any kind of orientation measurement, such as tilt angle, orientation with respect to x,y,z, access, acceleration (e.g., gravity) and so on in accordance with the desired implementation. Orientation sensor measurements can also involve gravity vector measurements to indicate the gravity vector of the device in accordance with the desired implementation. Mobile device 2300 can be configured to receive input from a keyboard, a mouse, a stylus, or any other input device through I/F 2306 in accordance with the desired implementation.

In example implementations, an artificial intelligence System on Chip (AI SoC) as illustrated in FIG. 2 executes a machine learning model on received televised content, the machine learning model configured to identify objects displayed on the received televised content. Accordingly, processor 2303 can be configured to execute a method or instructions involving displaying, through a mobile application interface, the identified objects for selection as illustrated at 1900 of FIG. 19; and for a selection of one or more objects from the identified objects and an overlay through the mobile application interface, modifying a display of the received televised content to display the overlay as illustrated in FIGS. 20 to 22.

Processor 2303 can be configured to execute the method or instructions as described above and further involve, for the overlay being an information overlay, retrieving information associated with the selected one or more objects; and generating the overlay from the retrieved information as illustrated in FIGS. 17A, 17B and 19.

Processor 2303 can be configured to execute the method or instructions as described above and further involve, for the overlay being a visual overlay, the modifying the display of the received televised content to display the overlay involves displaying the visual overlay on the selected one or more objects as illustrated on FIG. 11 and FIG. 20.

Processor 2303 can be configured to execute the method or instructions as described above, wherein the modifying a display of the received televised content to display the overlay involves for the selection of one or more objects from the identified objects being a selection of a person and an object, displaying the visual overlay on the object when the object is associated with the person as illustrated and described with respect to FIG. 11 and FIG. 20.

Processor 2303 can be configured to execute the method or instructions as described above, and further involve, for a selection of one or more users through the mobile application interface, modifying the display of the received televised content of the selected one or more users to display the overlay as illustrated in FIGS. 6B and 21.

Processor 2303 can be configured to execute the method or instructions as described above, and further involve retrieving information for display on the mobile application interface for the selected one or more objects as illustrated in FIG. 8 and FIG. 12.

Depending on the desired implementation, the AI SoC can be disposed on one of a television. a set top box, or an edge device connected to a set top box and a television as illustrated in FIGS. 3A to 3D. Processor 2303 can be configured to execute the method or instructions as described above and further involve receiving, through the mobile application interface, a channel to obtain the received television content as illustrated in FIG. 18.

Processor 2303 can be configured to execute the method or instructions as described above, and further involve receiving, through the mobile application interface, a selection of the machine learning model; wherein the AI SoC is configured to execute the selected machine learning model in response to the selection as described with respect to FIG. 6B.

Processor 2303 can be configured to execute the method or instructions as described above, and further involve receiving, through the mobile application interface, a selection of a location on the selected one or more objects to provide the overlay; wherein the modifying the display of the received televised content to display the overlay involves providing the overlay on the selected location on the selected one or more objects as illustrated in FIGS. 22 and 23.

Processor 2303 can be configured to execute the method or instructions as described above, wherein the overlay involves text messages; wherein the modifying the display of the received televised content to display the overlay involves modifying the display of a plurality of users to display the text messages as illustrated in FIGS. 13 and 14.

Processor 2303 can be configured to execute the method or instructions as described above, wherein, for the selection of the one or more objects being a first person having a first face and a second person having a second face, the overlay involves an overlay of the second face on the first person and an overlay of the first face on the second person as illustrated in FIG. 12.

Processor 2303 can be configured to execute the method or instructions as described above, and further involve, for the selection of the one or more objects being a person, generating a chat application in the mobile application interface to facilitate chat with the person as illustrated in FIG. 16.

Processor 2303 can be configured to execute the method or instructions as described above, and further involve receiving, through the mobile application interface, instructions to initiate a poll; wherein the poll is provided to mobile application interfaces of one or more users viewing the received television content as illustrated in FIG. 15.

Processor 2303 can be configured to execute the method or instructions as described above, wherein the overlay involves animations as illustrated in FIG. 11,

Processor 2303 can be configured to execute the method or instructions as described above, wherein the overlay involves statistics associated with the selected one or more objects as illustrated in FIG. 19.

Although example implementations described herein are described with respect to a mobile device and a television, other devices are also possible, and the present disclosure is not limited thereto. Other devices (e.g., computer, laptop, tablet, etc.) can also execute the application described herein to interact with a set-top box or other device configured to display television or video broadcasts. Further, the present disclosure is not limited to television or video broadcasts, but can be applied to other streaming content as well, such as internet streaming content, camera feeds from surveillance cameras, playback from peripheral devices such as from another tablet, video tapes from VCRs, DVDs, or other external media.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
executing, using an artificial intelligence System on Chip (AI SoC), a machine learning model on received televised content, the machine learning model configured to identify objects displayed on the received televised content;
displaying, through a mobile application interface, the identified objects for selection; and
for a selection of one or more objects from the identified objects and an overlay through the mobile application interface, modifying a display of the received televised content to display the overlay.

2. The method of claim 1, further comprising:
for the overlay being an information overlay, retrieving information associated with the selected one or more objects; and
generating the overlay from the retrieved information.

3. The method of claim 1, further comprising:
for the overlay being a visual overlay, the modifying the display of the received televised content to display the overlay comprises displaying the visual overlay on the selected one or more objects.

4. The method of claim 3, wherein the modifying the display of the received televised content to display the overlay comprises:
for the selection of one or more objects from the identified objects being a selection of a person and an object, displaying the visual overlay on the object when the object is associated with the person.

5. The method of claim 1, further comprising:
for a selection of one or more users through the mobile application interface, modifying the display of the received televised content of the selected one or more users to display the overlay.

6. The method of claim 1, further comprising retrieving information for display on the mobile application interface for the selected one or more objects.

7. The method of claim 1, wherein the AI SoC is disposed on one of a television. a set top box, or an edge device connected to a set top box and a television, wherein the method further comprises receiving, through the mobile application interface, a channel to obtain the received television content.

8. The method of claim 1, further comprising:
receiving, through the mobile application interface, a selection of the machine learning model;
wherein the AI SoC is configured to execute the selected machine learning model in response to the selection.

9. The method of claim 1, further comprising:
receiving, through the mobile application interface, a selection of a location on the selected one or more objects to provide the overlay;
wherein the modifying the display of the received televised content to display the overlay comprises providing the overlay on the selected location on the selected one or more objects.

10. The method of claim 1, wherein the overlay comprises text messages; wherein the modifying the display of the received televised content to display the overlay comprises modifying the display of a plurality of users to display the text messages.

11. The method of claim 1, wherein, for the selection of the one or more objects being a first person having a first face and a second person having a second face, the overlay comprises an overlay of the second face on the first person and an overlay of the first face on the second person.

12. The method of claim 1, further comprising, for the selection of the one or more objects being a person, generating a chat application in the mobile application interface to facilitate chat with the person.

13. The method of claim 1, further comprising, receiving, through the mobile application interface, instructions to initiate a poll;
wherein the poll is provided to mobile application interfaces of one or more users viewing the received television content.

14. The method of claim 1, wherein the overlay comprises animations.

15. The method of claim 1, wherein the overlay comprises statistics associated with the selected one or more objects.
